(19) United States
(12) Patent Application Publication
(10) Pub. No.: US 2012/0030918 A1
(43) Pub. Date: Feb. 9, 2012

(54) NOSE ASSEMBLY FOR FASTENER INSTALLATION TOOL

(76) Inventors: Douglas P. DeSalvo, Tucson, AZ (US); Robert Salazar, Tucson, AZ (US)

(21) Appl. No.: 13/016,028

(22) Filed: Jan. 28, 2011

Related U.S. Application Data
(60) Provisional application No. 61/300,302, filed on Feb. 1, 2010.

(51) Int. Cl. B23Q 1/00

(52) U.S. Cl. 29/283

(57) ABSTRACT

A nose assembly for a fastener installation tool having a housing, a piston received within the housing, a collet, a nose cap having an orifice and attached to the housing, and a seating anvil positioned between the first end of the piston and the nose cap. The anvil includes an extended front portion movable between a retracted position, in which the extended front portion is retained within the nose cap, and an extended position, in which the extended front portion advances through the orifice of the nose cap. The assembly engages a fastener having a sleeve, a pin, and a lock collar. The extended front portion of the anvil drives the lock collar to lock the pin and the sleeve with one another when the anvil is in its extended position and after a shifting pressure has been reached, the pin is set, and the sleeve is deformed by the pin.

### CROSS-REFERENCE TO RELATED APPLICATION

This application is a Section 111(a) application relating to commonly owned, co-pending U.S. Provisional Application Ser. No. 61/300,302 entitled “SELF-CONTAINED SHIFTING INSTALLATION NOSE ASSEMBLY,” filed Feb. 1, 2010, the entirety of which is incorporated herein by reference.

### FIELD OF THE INVENTION

The present invention relates to tools for installing mechanical fasteners and, more particularly, to nose assemblies of tools for installing mechanical fasteners having a lock collar.

### BACKGROUND OF THE INVENTION

Certain fasteners, such as blind bolt fasteners, require the insertion of a lock collar to mechanically lock a pin and sleeve of the fastener together at the completion of a fastener installation process. Having a lock collar installed between the pin and the sleeve increases stability and durability of the joint. The lock collar typically carries the installation loads until the pin presents its locking feature to the lock collar, at which time the lock collar moves to form the lock.

### SUMMARY OF THE INVENTION

In an embodiment, a nose assembly for a fastener installation tool includes a housing and a piston received within the housing. In an embodiment, the piston includes a first end and a second end opposite the first end, the second end of the piston being adapted to engage a fastener installation tool, and a collet having a fastener engagement end with a plurality of jaws. In an embodiment, the nose assembly includes a nose cap having an orifice, the nose cap being attached to the housing and engaging the first end of the piston. In an embodiment, the nose assembly includes a seating anvil positioned between the first end of the piston and the nose cap. In an embodiment, the seating anvil includes an extended front portion, the extended front portion of the seating anvil being movable between a retracted position, in which the extended front portion is retained within the nose cap, and an extended position, in which the extended front portion advances through the orifice of the nose cap.

In an embodiment, the nose assembly is adapted to engage a fastener having a sleeve, a pin that engages the sleeve, and a lock collar that mechanically locks the pin and the sleeve with one another. In an embodiment, the extended front portion of the seating anvil is adapted to drive the lock collar to mechanically lock the pin and the sleeve with one another when the seating anvil is in its extended position. In an embodiment, the nose assembly is preset with a shifting pressure. In an embodiment, the nose assembly senses a set position of the pin when a lock groove of the pin aligns with the lock collar. In an embodiment, the seating anvil is moved to its extended position after the shifting pressure has been reached and the pin and the sleeve have been set. In an embodiment, the nose assembly exerts no pressure on the lock collar of the fastener when the pin and the sleeve are being set.

In an embodiment, the nose assembly includes a hydraulic shifting mechanism. In an embodiment, the hydraulic shifting mechanism includes a sealed, self-contained hydraulic control valve. In an embodiment, the nose assembly includes a pneumatic shifting mechanism.

### BRIEF DESCRIPTION OF THE DRAWINGS

Reference is made to the following detailed description of the embodiments considered in conjunction with the accompanying drawings, in which:

FIG. 1 is a side cross-sectional view of a nose assembly for a fastener installation tool in accordance with an embodiment of the present invention, the nose assembly being shown engaged with a fastener in an initial step of a fastener installation process;

FIG. 2 is a side cross-sectional view of the nose assembly shown in FIG. 1, which is shown engaged with a fastener in a subsequent step of the fastener installation process;

FIG. 3 is a side cross-sectional view of the nose assembly shown in FIG. 2, which is shown engaged with a fastener in a subsequent step of the fastener installation process;

FIG. 4 is a side cross-sectional view of the nose assembly shown in FIG. 3, which is shown engaged with a fastener in a subsequent step of the fastener installation process;

FIG. 5 is a side cross-sectional view of the nose assembly shown in FIG. 4, which is shown engaged with a fastener in a subsequent step of the fastener installation process; and

FIG. 6 is a side cross-sectional view of the nose assembly shown in FIG. 5, which is shown in a subsequent step of the fastener installation process.

### DETAILED DESCRIPTION OF THE EXEMPLARY EMBODIMENTS

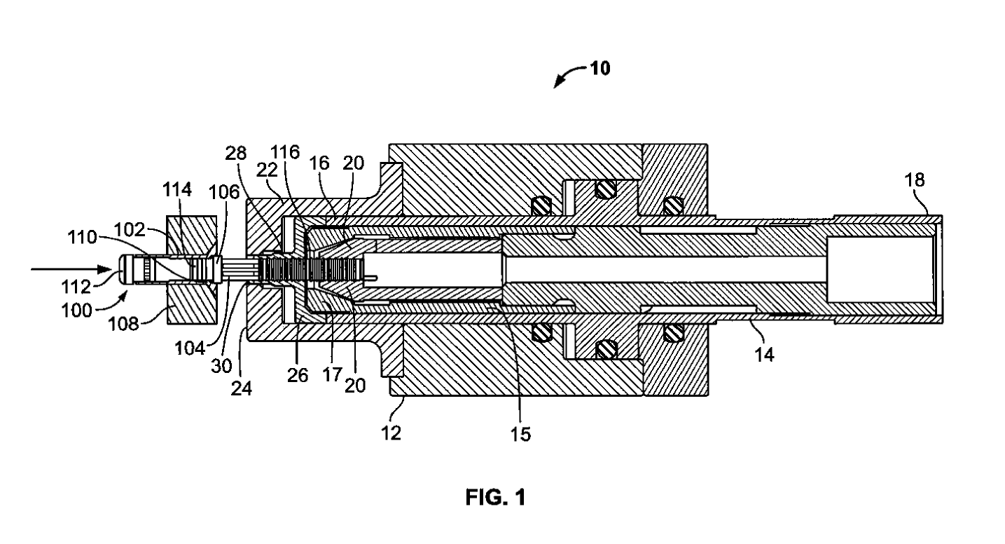

Referring to FIG. 1, in an embodiment, a nose assembly 10 for an installation tool includes a housing 12 and a piston 14 received within the housing 12 and having a first end 16 and a second end 18 opposite the first end 16. In an embodiment, the second end 18 of the piston is operationally attached to a fastener installation tool (not shown in the Figures). In an embodiment, the piston 14 includes a collet 15 having a fastener engagement end 17 having a plurality of jaws 20. In an embodiment, the housing 12 includes a nose cap 22 that engages and caps the first end 16 of the piston 14. In an embodiment, the nose cap 22 includes an external surface 24, whose purpose shall be described hereinafter. In an embodiment, the nose assembly 10 includes a seating anvil 26 that is positioned between the nose cap 22 and the first end 16 of the piston 14. In an embodiment, the seating anvil 26 moves within the nose cap 22 and is operationally connected to the piston 14. In an embodiment, the seating anvil 26 has an extended front portion 28 that advances through an orifice 30 of the nose cap 22. The purpose and function of the seating anvil 26 shall be described hereinafter.

Still referring to FIG. 1, in an embodiment, the nose assembly 10 is adapted to engage a fastener 100 having a sleeve 102, a pin 104 and a lock collar 106. The fastener 100 is inserted into a hole of a work piece 108. In an embodiment, the lock collar 106 resides in a locking pocket 110 of the sleeve 102. In an embodiment, the pin 104 includes a head portion 112 and a lock groove 114. In an embodiment, a pull portion or pintail 116 of the pin 104, which is inserted through the nose cap 22 and seating anvil 26 and into the housing 12 of the nose assembly 10. In an embodiment, the jaws 20 of the collet 15 grip the pintail 116 of the pin 104. In an embodiment, the seating anvil 26 surrounds the pintail 116 of the pin 104.

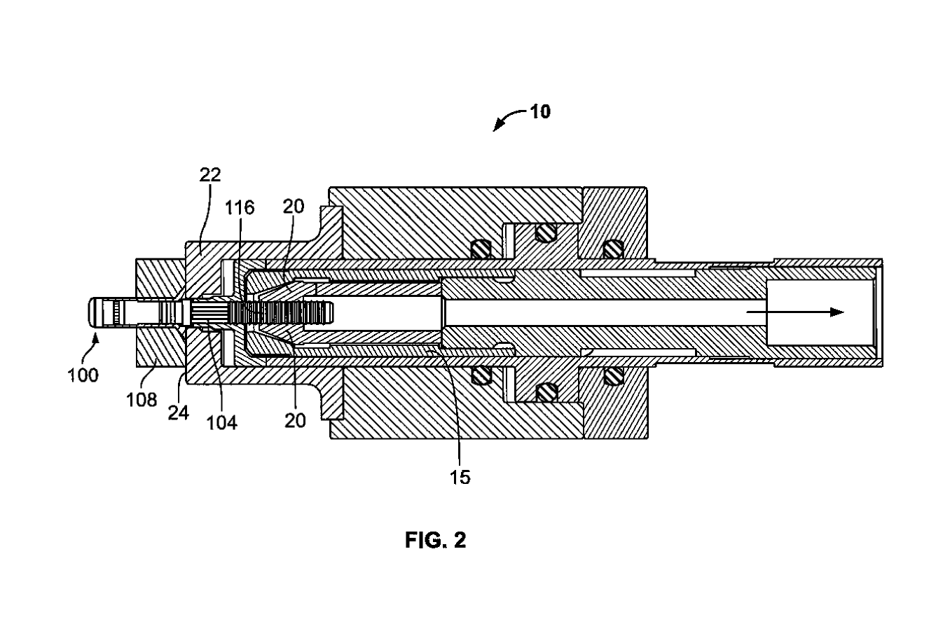

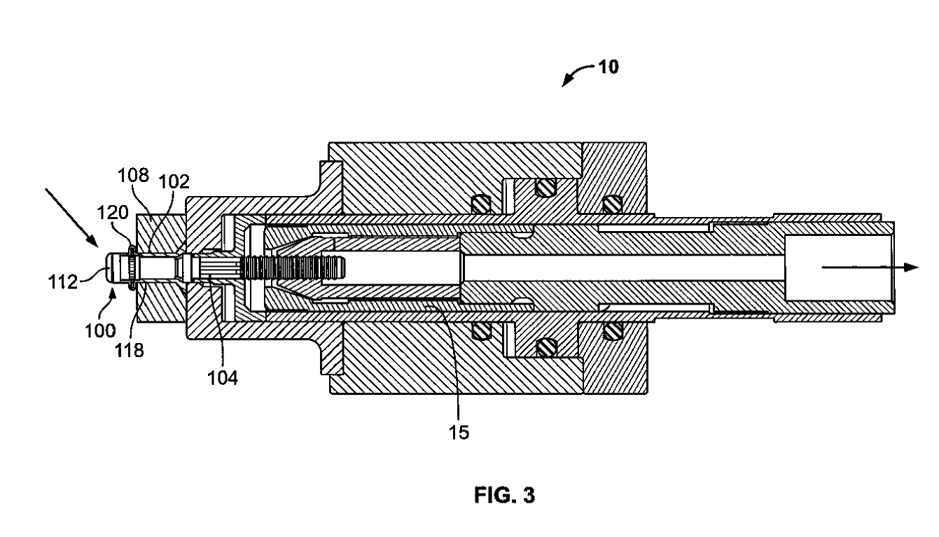

Referring to FIG. 2, in an embodiment, the jaws 20 of the collet 15 of the nose assembly 10 continue to grip the pintail 116 of the pin 104, and the collet 15 is pulled away from the nose cap 22 by a force generated by the tool. As a result, the collet 15 pulls the pintail 116 of the pin 104, and the surface 24 of the nose cap 22 engages the workpiece 108. Referring to FIG. 3, in an embodiment, as the pin 104 is pulled by the collet 15, the head portion 112 of the pin 104 presses on a free wall portion 118 of the sleeve 102 extending from the work piece 108, and deforms the free wall portion 118 to form a bulb 120.

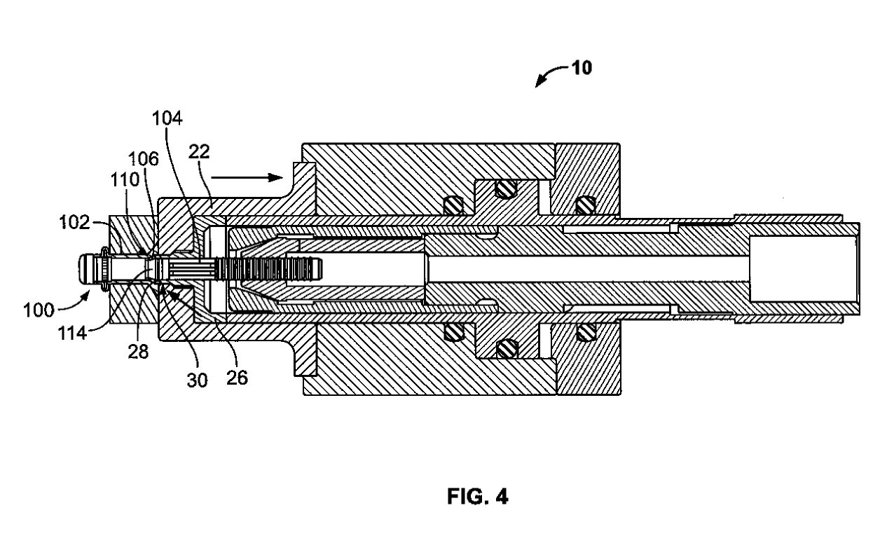

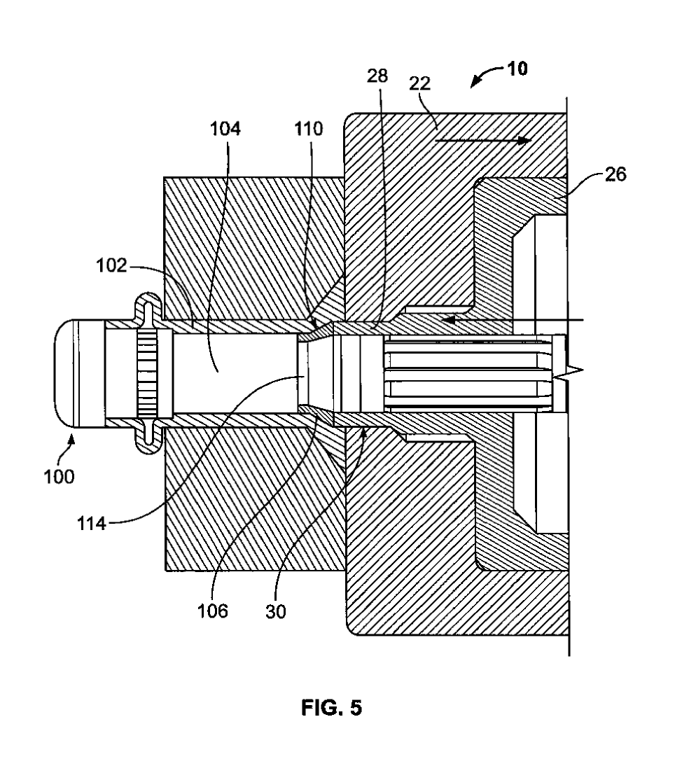

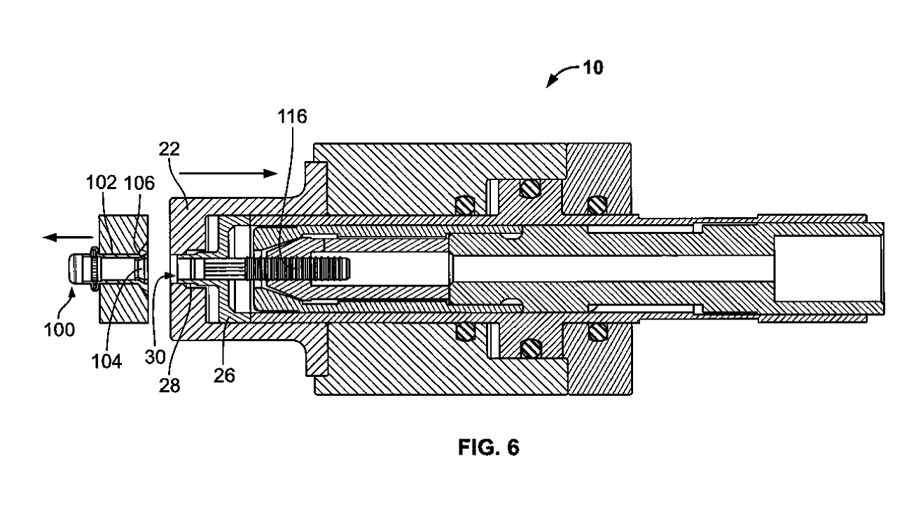

Referring to FIG. 4, in an embodiment, a shift pressure is reached and the pin 104 is set and the sleeve 102 is upset (i.e., deformed), the extended front portion 28 of the seating anvil 26 advances through the orifice 30 of the nose cap 22 and drives the lock collar 106 into the locking pocket 110 of the sleeve 102 and into the lock groove 114 of the pin 104, creating a mechanical lock between the sleeve 102 and the pin 104. FIG. 5 shows a detailed view of this step of the installation process. Referring to FIG. 6, in an embodiment, after the extended front portion 28 of the seating anvil 26 drives the lock collar 106 to create a mechanical lock between the sleeve 102 and the pin 104 the fastener 100 is set, and the seating anvil 26 retracts and the extended front portion 28 retracts through the orifice 30 of the nose cap 22. In an embodiment, the pintail 116 is broken off from the pin 104, dropping into a catching bag (not shown in the Figures), leaving no foreign object debris.

As described above, the nose assembly 10 allows for the installation of the lock collar 106 after the pin 104 is set and the sleeve 102 is upset (i.e., deformed) by the pin 104. In an embodiment, the nose assembly 10 exerts no or a minimal pressure on the lock collar 106 while the nose assembly 10 pulls the pin 104 away from the work piece 108. In an embodiment, by separating an action of pulling the pin 104 to upset the sleeve 102 and an action of setting the lock collar 106 to mechanically lock the pin 104 and the sleeve 104 in the set fastener 100, the nose assembly 10 provides the installation tool with a capability to sense the set position of the pin 104. In an embodiment, the nose assembly 10 separates the action of setting the pin 104 and automatically driving the lock collar 106 by sensing either (1) when the lock groove 114 of the pin 104 aligns with the lock collar 106, or (2) when a predetermined pulling pressure on the pin 104 is reached. In an embodiment, during the installation process, the nose assembly 10 senses when the matching locking groove 114 of the pin 104 becomes available and drives in the lock collar 106 while the pin 104 still continues to be set. In an embodiment, the nose assembly 10 allows users of the installation tool to confirm that the fastener 100 is installed correctly in a proper grip range. In an embodiment, the nose assembly 10 adapts to existing installation tools.

In some embodiments, the nose assembly 10 is preset to initiate the shift to seat the lock collar 106 when a preset pressure condition occurs. In an embodiment, Table 1 below provides an exemplary correspondence between fasteners having certain diameters and the preset pressures at which the embodiments of the invention switch from primarily pulling on the pin 104 to setting the lock collar 106.

TABLE 1

| Material & Diameter | Shift Load in Lbf |
|---|---|
| CRES 5 Dia | 1,200 to 1,500 |
| CRES 6 Dia | 1,800 to 2,100 |
| Alloy Steel 5 Dia | 1,400 to 1,700 |
| Alloy Steel 6 Dia | 2,200 to 2,500 |

In some embodiments, the nose assembly 10 employs a hydraulic shifting mechanism. In some embodiments, the nose assembly 10 employs a factory sealed, fully self-contained, hydraulic control valve. In some embodiments, the nose assembly 10 employs a pneumatic shifting mechanism. In some embodiments, the nose assembly 10 is maintenance-free and tamper-proof and never needs adjustment in service. In some embodiments, the nose assembly 10 allows to maintain a continuous installation consistency for a prolonged use period of a tool equipped with the nose assembly 10. In some embodiments, the factory preset condition of the nose assembly 10 requires no adjustments during operation, even if different batches of fasteners are to be installed. In some embodiments the nose assembly 10 eliminates a need for having fasteners with any additional components, such as commonly used “drive anvils/washers;” thus eliminating or minimizing the risks associated with discarded fastener components that create foreign object debris that may be retained in a production structure.

It will be understood that the nose assembly 10 described herein is merely exemplary and that a person skilled in the art may make many variations and modifications without departing from the full spirit and the scope of the embodiment described herein. Accordingly, all such variations and modifications are intended to be included within the scope of the invention as defined in the appended claims.

What is claimed is:

1. A nose assembly for a fastener installation tool, comprising:
a housing;
a piston received within the housing, the piston having a first end and a second end opposite the first end, wherein the second end of the piston is adapted to engage a fastener installation tool, and a collet having a fastener engagement end with a plurality of jaws;
a nose cap having an orifice, the nose cap being attached to the housing and engaging the first end of the piston; and
a seating anvil positioned between the first end of the piston and the nose cap, wherein the seating anvil includes an extended front portion, the extended front portion of the seating anvil being movable between a retracted position, in which the extended front portion is retained within the nose cap, and an extended position, in which the extended front portion advances through the orifice of the nose cap.

2. The nose assembly of claim 1, wherein the nose assembly is adapted to engage a fastener having a sleeve, a pin that engages the sleeve, and a lock collar that mechanically locks the pin and the sleeve with one another.

3. The nose assembly of claim 2, wherein the extended front portion of the seating anvil is adapted to drive the lock collar to mechanically lock the pin and the sleeve with one another when the seating anvil is in its extended position.

4. The nose assembly of claim 3, wherein the nose assembly is preset with a shifting pressure.

5. The nose assembly of claim 4, wherein the seating anvil is moved to its extended position after the shifting pressure has been reached, the pin is set, and the sleeve is deformed by the pin.

6. The nose assembly of claim 5, wherein the nose assembly exerts no pressure on the lock collar of the fastener when the pin and the sleeve are being set.

7. The nose assembly of claim 6, wherein the nose assembly includes a hydraulic shifting mechanism.

8. The nose assembly of claim 7, wherein the hydraulic shifting mechanism includes a sealed, self-contained hydraulic control valve.

9. The nose assembly of claim 6, wherein the nose assembly includes a pneumatic shifting mechanism.

10. The nose assembly of claim 2, wherein the nose assembly senses a set position of the pin when a lock groove of the pin aligns with the lock collar.
